(19) United States
(12) Patent Application Publication
(10) Pub. No.: US 2006/0055895 A1
(43) Pub. Date: Mar. 16, 2006

(54) Projection apparatus

(76) Inventors: Seok-il Yoon, Daejeon Maetropolitan-city (KR); Sung-gi Kim, Suwon-si (KR); Young-il Kah, Suwon-si (KR)

Correspondence Address: Stanzione & Kim, LLP, Suite 440, 919 18th Street, NW, Washington, DC, 20006, US

(21) Appl. No.: 11/224,237

(22) Filed: Sep. 13, 2005

(30) Foreign Application Priority Data
Sep. 15, 2004 (KR) 2004-73921

(51) Int. Cl. G03B 21/26

(52) U.S. Cl. 353/94

(57) ABSTRACT

A projection apparatus includes a plurality of display devices to generate different color images, a plurality of projection lens units to magnify and project the images generated from the display devices, and a screen to display the projected images. The display devices are three-dimensionally arranged such that the display devices are concentrated around a reference axis that is a central axis of an arrangement of the display devices.

### CROSS-REFERENCE TO RELATED APPLICATIONS

This application claims the benefit of Korean Patent Application No. 2004-73921, filed on Sep. 15, 2004, in the Korean Intellectual Property Office, the disclosure of which is incorporated herein in its entirety by reference.

### BACKGROUND OF THE INVENTION

1. Field of the Invention

The present general inventive concept relates to a projection apparatus, and more particularly, to a color projection television apparatus utilizing three display devices.

2. Description of the Related Art

An image projection system, such as a projection television or a video projector, is designed to generate an image using a display device, such as a small cathode ray tube (CRT) specially manufactured, and magnify and project the generated image using a projection lens unit onto a large screen. Such an image projection system is much in demand as a user is satisfied with the large screen. The image projection system can be classified into a front projection system and a rear projection system according to an image magnifying/projecting method to a screen.

The image projection system forms an image on a screen by projecting light from an image source onto the screen so that a viewer located in front of the screen can identify the image. When the viewer watches the screen, it is preferable that the viewer is located in center-front of the screen. However, since the viewer may be located in left-front or right-front of the screen or in a location higher or lower than the screen, it is preferable that the image projection system has a wide viewing angle in both horizontal and vertical directions.

FIG. 1 shows an example of a conventional projection television.

Referring to FIG. 1, the conventional projection television includes a cabinet 10, a screen 20 installed on a front of the cabinet 10 to display an image, red (R), green(G) and blue(B) display devices 11R, 11G and 11B installed in the cabinet 10 to generate R, G and B images, three projection lens units 13a, 13b and 13c magnifying and projecting the images generated from the R, G and B display devices 11R, 11G and 11B, and a reflection mirror 15 reflecting the images emitted from the R, G and B display devices 11R, 11G and 11B toward the screen 20.

Small sized CRTs may be used as the R, G and B display devices 11R, 11G and 11B generating and projecting the R, G and B images.

In the projection television, the image is projected to a rear of the screen 20 so that the viewer watches the image in a state where the viewer is located in front of the screen.

As shown in FIG. 2, the R, G and B display devices 11R, 11G and 11B are linearly arranged side by side. As shown in FIG. 3, the R, G and B display devices 11R, 11G and 11B are disposed within a circle arc of a radius identical to a total conjugate length of the projection lens units 13a, 13b and 13c.

That is, referring to FIG. 3, the R and B display devices 11R and 11B are arranged having a predetermined concentrating angle around the G display device 11G located on a z-axis. The concentrating angle is generally within a range of 8-12°.

In order to improve a color shift incurred by the arrangement of the R. G and B display devices 11R, 11G and 11B, as shown in FIG. 4, the screen 20 includes a Fresnel lens sheet 21 and a dual lenticular lens sheet 23 provided at both sides with lens arrays.

However, in the conventional projection television, since the R. G and B display devices are linearly arranged, the concentrating angle is enlarged, thereby deteriorating a focusing characteristic and not providing a sufficient convergence adjusting margin. As a result, focus and convergence deviations may be easily incurred according to a time/temperature variation.

### SUMMARY OF THE INVENTION

The present general inventive concept provides a projection apparatus that is designed to have an improved focusing characteristic and provide a sufficient convergence adjusting margin by arranging display devices to minimize a concentrating angle.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a projection television apparatus including a plurality of display devices to generate different color images, a plurality of projection lens units to magnify and project the images generated from the display devices, and a screen to display the projected images, wherein the display devices are three-dimensionally arranged such that the display devices are concentrated around a reference axis that is a central axis of an arrangement of the display devices.

The display devices may be three-dimensionally arranged to be located on a spherical surface of a sphere having a radius identical to a total conjugate length of the projection lens units.

The display devices may be arranged to be located on a plurality of circular arcs passing through the reference axis.

The display devices may include first, second and third display devices, wherein first and second display devices may be arranged to be located on a first circular arc crossing the reference axis and the third display device may be arranged to be located on a second circular arc crossing the reference axis.

The first and second display devices may be symmetrically arranged to have an identical concentrating angle with respect to the reference axis.

The first and second display devices can be located on the first circular arc in parallel with a horizontal direction and the third display device may be located on the second circular arc that is perpendicularly cross the first circular arc.

The third display device may be arranged to have the concentrating angle different from those of the first and second display devices.

The third display device may be located at a predetermined angle with respect to a plane perpendicular to a plane where the first and second display devices are located.

At least one of the display devices may be arranged to have the concentrating angle different from those of the other display devices.

The screen may include a Fresnel lens to refract incident light to be parallel light and first and second lenticular lenses to diffuse the image passing through the Fresnel lens to enlarge a viewing angle and to correct a color shift.

The first and second lenticular lenses may be formed of a dual lenticular lens having incidence and emitting lenses.

One of the first and second lenticular lenses may be arranged such that a longitudinal axis thereof is perpendicular to a direction in which the first and second display devices are arranged, and the other one of the first and second lenticular lenses may be arranged such that a longitudinal axis thereof is perpendicular to a direction where the third display device is arranged with respect to the reference axis.

The foregoing and/or other aspects of the present general inventive concept may also be achieved by providing a projection television apparatus including first, second, and third display devices to generate different images, the first and third display devices disposed on a first circular line, and the second display device disposed on a second circular line different from the first circular line, a projection lens unit to magnify and project the images generated from the display devices, and a screen to display the projected images.

The foregoing and/or other aspects of the present general inventive concept may also be achieved by providing a projection apparatus including first, second, and third display devices to generate different images, the first and third display devices disposed on a plane including a central axis of an arrangement of the first, second, and third display devices, the second display device spaced-apart from the plane, and a screen to display the generated images.

The foregoing and/or other aspects of the present general inventive concept may also be achieved by providing a projection television apparatus including first, second, and third display devices respectively disposed on first, second, and third planes each including a common reference axis which is a central axis of an arrangement of the first, second, and third display devices, the second display device spaced-apart from the first and third planes; and a screen to display the generated images.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an example of a conventional projection television;

FIG. 2 is a schematic view illustrating an arrangement of R, G and B display devices on a y-z plane in the projection television of FIG. 1;

FIG. 3 is a schematic view illustrating an arrangement of R, G and B display devices on an x-y plane in the projection television of FIG. 1;

FIG. 4 is a sectional view illustrating a screen of the projection television of FIG. 1;

FIG. 5 is a schematic view of a projection television according to an embodiment of the present general inventive concept;

FIG. 6 is a schematic view illustrating a three-dimensional arrangement of R, G and B display devices of the projection television of FIG. 5;

FIG. 7 is a view illustrating R, G and B display devices arranged on a curved surface of a circular cone whose vertex is a center of a sphere and having a predetermined conical angle in the projection television of FIG. 5;

FIG. 8A is a schematic view illustrating an arrangement of R, G and B display devices on an x-y plane in the projection television of FIG. 5;

FIG. 8B is a schematic view illustrating an arrangement of R, G and B display devices on an x-z plane in the projection television of FIG. 5;

FIG. 9 is an exploded perspective view illustrating a screen having a structure to be proper to the arrangement of the R, G and B display devices of FIG. 7;

FIG. 10A is a schematic view illustrating the screen on an x-z plane in the projection television of FIGS. 5 and 7;

FIG. 10B is a schematic view illustrating the screen an x-y plane in the projection television of FIGS. 5 and 7;

FIG. 11 is a view illustrating the R, G and B display devices arranged on a curved surface of a circular cone having a predetermined cone angle in the projection television of FIG. 5, so that the R and B display devices are disposed on an x-y plane in a horizontal direction and the G display device is disposed on a line having a predetermined angle with respect to the x-z plane;

FIG. 12 is an exploded perspective view illustrating the screen having a structure to be proper to the arrangement of the R, G and B display devices as shown in FIG. 11;

FIG. 13 is a graph illustrating a brightness variation according to a viewing angle in a horizontal direction of the projection television of FIGS. 5 and 7;

FIG. 14 is a graph illustrating a brightness variation according to a viewing angle in a vertical direction of the projection television of FIGS. 5 and 7;

FIG. 15 is a graph illustrating a color shift according to a viewing angle in a horizontal direction of the projection television of FIGS. 5 and 7; and

FIG. 16 is a graph illustrating a color shift according to a viewing angle in a vertical direction of the projection television of FIGS. 5 and 7.

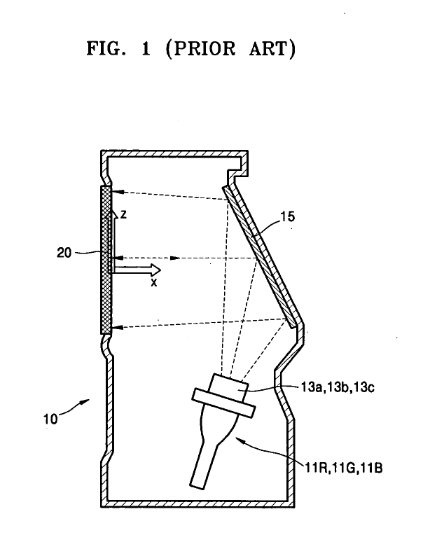

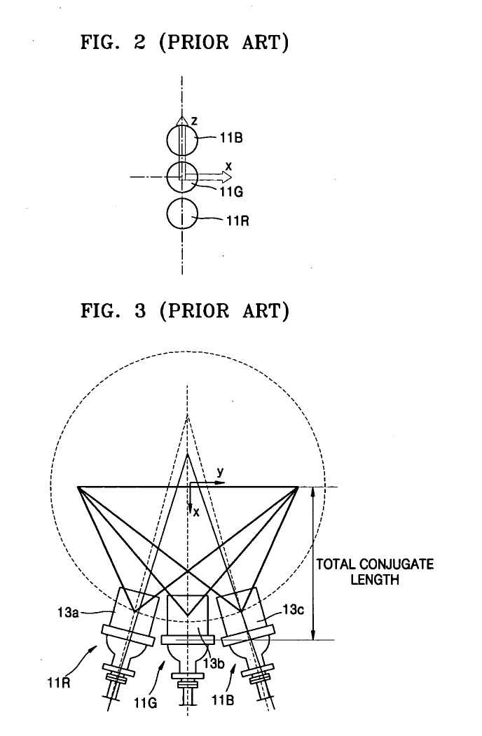

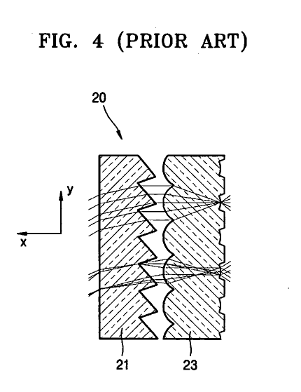

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

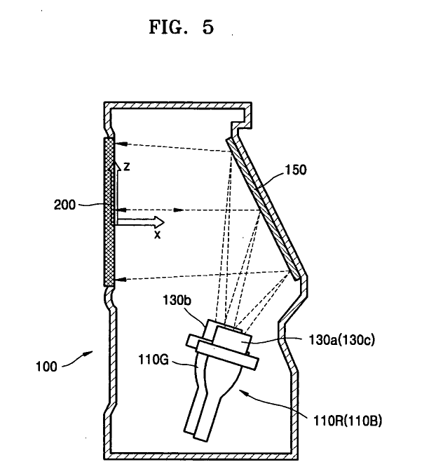

FIG. 5 is a view illustrating a projection apparatus, for example, a projection television, according to an embodiment of the present general inventive concept.

Referring to FIG. 5, the projection television includes a cabinet 100, a screen 200 installed on a front of the cabinet 100 to display an image, red (R), green(G) and blue(B) display devices 110R, 110G and 110B installed in the cabinet 100 to generate R, G and B images, three projection lens units 130a, 130b and 130c to magnify and project the images generated from the R, G and B display devices 110R, 110G and 110B, and a reflection mirror 150 to reflect the images emitted from the R, G and B display devices 110R, 110G and 110B toward the screen 20.

In the projection television, the image is projected to a rear of the screen 200 so that the viewer watches the image in a state where the viewer is located in front of the screen.

In order to realize R, G and B color images, CRTs may be utilized as the R, G, and B display devices 110R, 110G, and 110B to generate and project the R, G, and B color images, respectively. The projection lens units 130a, 130b and 130c are arranged to magnify and project images irradiated to output ends of the R, G and B display devices 110R, 110G and 110B. Here, the R, G and B display devices 110R, 110G and 110B and the projection lens units 130a, 130b and 130c located on the respective output ends of the R, G and B display devices 110R, 110G and 110B may be integrally coupled to each other.

The R, G and B display devices 110R, 110G and 110B are arranged to be capable of minimizing a concentrating angle with respect to a reference axis A (FIG. 7). The reference axis A can be a central axis of the arrangement of the R, G and B display devices 110R.

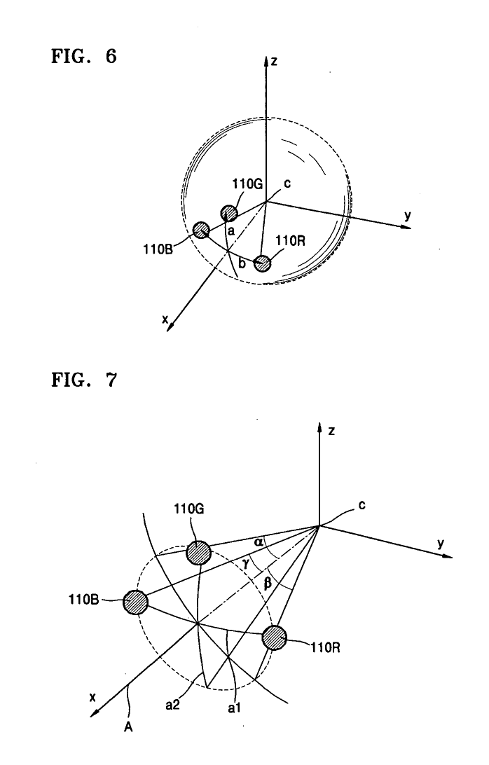

Referring to FIG. 6, in order to allow the R, G and B display devices 110R, 110G and 110B to be capable of minimize the concentrating angle, the R, G and B display devices 110R, 100G and 110B are not arranged on a two-dimensional plane but on a three-dimensional plane. Accordingly, each of the R, G and B display devices 110R, 110G and 110B is arranged at a predetermined concentrating angle with respect to the reference axis A. For example, at least one of the R, G and B display devices 110R, 110G and 110B may be arranged to have the concentrating angle different from that of other display devices. It is also possible that the concentrating angles of the R, G and B display devices 110R, 110G and 110B are different from one another.

In FIGS. 6, 7 and 11, the R, G and B display devices 110R, 110G and 110B are represented as a circle for the descriptive convenience.

As shown in FIG. 6, the R, G and B display devices 110R, 110G and 110B may be three-dimensionally arranged on a surface of a sphere having a radius identical to a total conjugate length (TCL) of the projection lens units 130a, 130b and 130c.

At this point, phosphor surface rasters (effective display area of the CRT) of the CRTs used as the R, G and B display devices 110R, 110G and 110B are located on the sphere surface.

The reference character c in FIG. 6 indicates a center of the sphere having the radius identical to the TCL. Here, the R, G and B display devices 110R, 110G and 110B can be freely arranged on the sphere surface within a range defined by a desired concentrating angle value of the projection lens units 130a, 130b and 130c. Each concentrating angle of the R, G and B display devices 110R, 110G and 110B is an angle of the display devices 110R, 110G and 110B with respect to the reference axis A that is a center of the arrangement of the R, G and B display devices 110R, 110G and 110B.

In FIG. 6, when an x-axis passing through a center “c” of the sphere is the reference axis A, a direction of a y-axis is a horizontal direction, and a direction of a z-axis is a vertical direction. The x axis may be a line parallel to one of lengthwise directions of R, G and B display devices 110R, 110G and 110B. The lengthwise directions of the R, G, and B display devices 110R, 110G, and 110B have the concentrating angles with the reference axis A.

The R, G and B display devices 110R, 110G and 110B may be arranged on predetermined locations disposed on a plurality of circular arcs passing through the reference axis A on the sphere. In FIG. 6, a reference character “a” indicates a first circular arc on which the G display device 110G is located, and a reference character “b” indicates another circular arc on which the R and B display devices 110R and 110B are located. Each of the circular arcs “a” and “b” is a portion of a circle formed by connecting points on a sphere surface, the points being identically distant from the center of the sphere. That is, there are a myriad of such circles and circular arcs on the sphere surface.

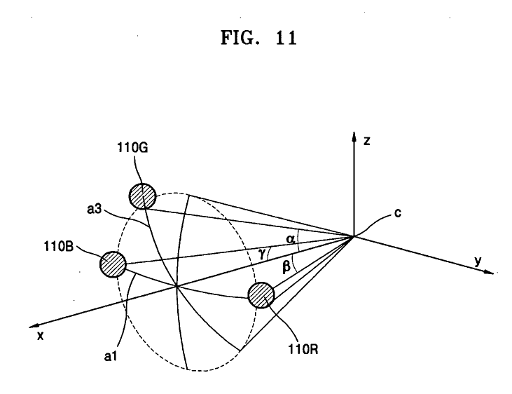

Referring to FIGS. 7 and 11, two of the R, G and B display devices 110R, 110G and 110B may be located on a first circular arc a1 crossing the reference axis A and the remaining one of the R, G and B display devices 110R, 110G and 110B may be located on a second circular arc a2 or a3 crossing the reference axis A. Alternatively, the R, G and B display devices 110R, 110G and 110B may be located on respective different circular arcs crossing the reference axis A.

Concentrating angles β, α, and γ of the R, G and B display devices 110R, 110G and 110B may be different from one another. Alternatively, two of the concentrating angles of the R, G and B display devices 110R, 110G and 110B may be identical to each other and the remaining one of the R, G and B display devices 110R, 110G and 110B may be different from those of the two concentrating angles of the R, G and B display devices 110R, 110G and 110B. In addition, when two of the R, G and B display devices 110R, 110G and 110B are arranged in a horizontal direction, the remaining one of the R, G and B display devices 110R, 110G and 110B may be arranged on a plane obtained by the vertical direction and the reference axis A or may be arranged to be inclined from the plane at a predetermined angle.

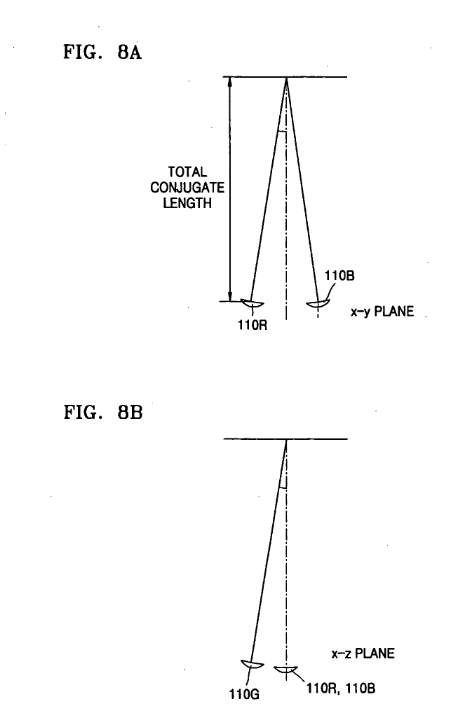

FIGS. 7 through 8B illustrate an arrangement of the R, G and B display devices 110R, 110G and 110B of FIG. 5.

FIG. 7 illustrates the R, G and B display devices 110R, 110G and 110B arranged on a curved surface of a circular cone whose vertex is a center point of a sphere and having a predetermined conical angle, FIG. 8A illustrates an arrangement of the R, G and B display devices 110R, 110G and 110B on an x-y plane in the projection television of FIG. 5, and FIG. 8B shows the R, G and B display devices 110R, 110G and 110B on an x-z plane in the projection television of FIG. 5. Here, the x-y plane is in parallel with the horizontal direction and the x-z plane is in parallel with the vertical direction.

As shown in FIGS. 7 through 8B, the R and B display devices 110R and 110B may be located on the x-y plane and the G display device 110G may be located on the x-z plane.

In FIG. 7, the concentrating angles β, α and γ can be direction cosine angles of the R, G and B display devices 110R, 110G and 110B with respect to the x-axis, for example, the reference axis A that is a central axis of the circular cone, respectively.

FIGS. 7 through 8B show a case where the R and B display devices 110R and 110B pass through the x-axis, being arranged on both points of the first circular arc a1 that is in parallel with the x-y plane. In addition, the G display device 110G is arranged on the second circular arc a2 perpendicularly crossing the first circular arc a1 on the x-axis.

As shown in FIG. 7, the R and B display devices 110R and 110B may be arranged in a direction, for example, a horizontal direction or a direction of the y-axis, at both sides of the reference axis A to have an identical concentrating angle (β=γ) with respect to the reference axis A. The G display device 110G may be arranged in a vertical direction, i.e., in the direction of the z-axis with a different concentrating angle α with respect to the reference axis A. Here, the G display device 110G may be arranged to have a concentrating angle less than those of the R and B display devices 110R and 110B. Alternatively, the R and B display devices 110R and 110B may be arranged to have a concentrating angle less than that of the G display device 110G.

When the R, G and B display devices 110R, 110G and 110B are three-dimensionally arranged as shown in FIG. 7, the R, G and B display devices 110R, 110G and 110B may be arranged to have a concentrating angle that is less than a conventional concentrating angle of 8-12°. When the concentrating angle is reduced, since a focusing characteristic can be improved and a convergence adjusting margin can be sufficiently obtained, a display quality of the projection apparatus can be improved. Furthermore, the focus and convergence deviation incurred due to a variation of the time/temperature can be improved.

When the R, G and B display devices 110R, 110G and 110B are arranged as shown in FIGS. 7 through 8B, the direction cosine angle α of the G display device 110G may be about 2.90°, each of the direction cosine angles β and γ of the respective R and B display devices 110R and 110B may be 4.41°. That is, when the R, G and B display devices 110R, 110G and 110B are three-dimensionally arranged, the R, G and B display devices 110R, 110G and 110B may be arranged to have the concentrating angle that is about 50% of a conventional concentrating angle of 8-12°.

As described above, when the R, G and B display devices 110R, 110G and 110B are three-dimensionally arranged, since the R, G and B display devices 110R, 110G and 110B can be disposed to get closer to each other, the concentrating angles of the projection lens units 130a, 130b and 130c disposed on respective front ends of the the R, G and B display devices 110R, 110G and 110B can be reduced. As a result, the arrangement of the R, G and B display devices 110R, 110G and 110B provides an optical system that can improve the focusing characteristic and reduce the distortion.

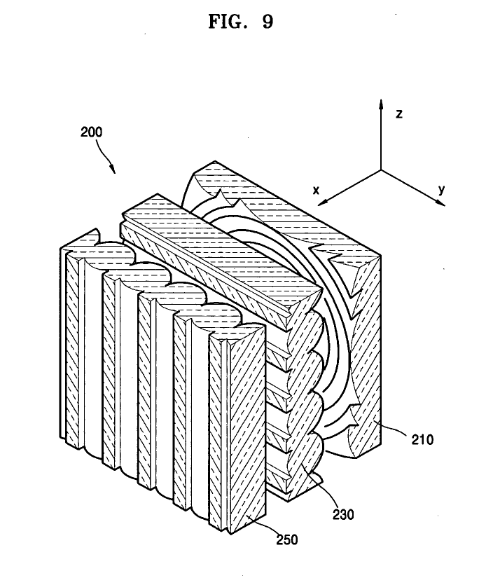

FIG. 9 illustrates the screen 200 of the projection television of FIG. 5. The screen 200 has a structure to arrange the R, G and B display devices, as shown in FIG. 7.

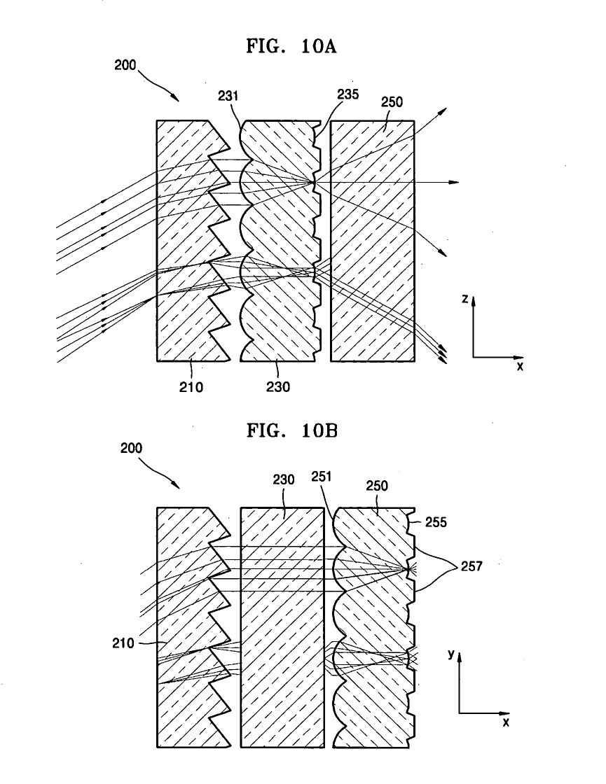

FIG. 10A illustrates the screen 200 on an x-z plane in the projection television of FIG. 5, and FIG. 10B illustrates the screen 200 on an x-y plane in the projection television of FIG. 5.

As shown in FIGS. 9 through 10B, the screen 200 includes a Fresnel lens 210 to refract light proceeding from the reflection mirror 150 to be parallel light and first and second lenticular lenses 230 and 250 disposed in front of the Fresnel lens 210 to correct a color shift while increasing a viewing angle by spreading the image passing through the Fresnel lens 210. The screen 200 may further include a protective layer (not shown) to protect the Fresnel lens 210 as well as the first and second lenticular lenses 230 and 250. The Fresnel lens 210 and the first and second lenticular lenses 230 and 250 may be formed of sheets.

The Fresnel lens 210 is designed to have a predetermined refraction to control a watching distance between the viewer and the projection television.

One of the first and second lenticular lenses 230 and 250 may be arranged such that a longitudinal axis thereof is perpendicular to a direction in which two of the R, G and B display devices 110R, 110G and 110B are arranged, and the other one of the first and second lenticular lenses 230 and 250 may be arranged such that a longitudinal axis thereof is perpendicular to a direction where the remaining one of the R, G and B display devices 110R, 110G and 110B is arranged with respect to the reference axis A. Here, the arrangement direction of the two of the R, G and B display devices 110R, 110G and 110B is a direction in parallel with an axis passing through the reference axis A and connecting the two of the R, G and B display devices 110R, 110G and 110B.

The first lenticular lens 230 is arranged to cooperate with the G display device 110G, and the second lenticular lens 250 is arranged to cooperate with the R and B display devices 110R and 110B. In FIGS. 9, 10B and 12, the first lenticular lens 230 is located between the second lenticular lens 250 and the Fresnel lens 210. However, the locations of the first and second lenticular lenses 230 and 250 may be exchanged with respect to the Fresnel lens 210.

A lengthwise direction of lenticules of the first lenticular lens 230 may be arranged at a first angle with respect to a direction, for example, the horizontal direction, where the R and B display devices 110R and 110b are arranged. The first angle may be identical to that of the G display device 110G with respect to the x-z plane (a plane obtained by a vertical direction and the reference axis A).

When the G display device 110G is arranged in parallel with the x-z plane as shown in FIG. 7, a longitudinal axis of the lenticules of the first lenticular lens 230 is arranged such that the longitudinal axis thereof is in parallel with the horizontal direction as shown in FIGS. 9 through 10B.

The second lenticular lens 250 are arranged such that a second longitudinal direction of lenticules thereof is in parallel with a direction perpendicular to the direction in which the R and B display devices 110R and 110B are arranged.

In FIG. 7, the direction in which the R and B display devices 110R and 110B are arranged may be a direction of the y-axis (i.e., the horizontal direction).

As described above, when the direction in which the R and B display devices 110R and 110B are arranged in the horizontal direction, the second longitudinal direction of the lenticules of the second lenticular lens 250 is arranged such that the longitudinal axis thereof is in parallel with the vertical direction. In this case, the second lenticular lens 250 diffuses incident light in the horizontal direction to enlarge the viewing angle of the horizontal direction and corrects the color shift in the horizontal direction that may be caused by the concentrating angles β and γ of the R and B display devices 110R and 110B in the horizontal direction.

In FIGS. 7 through 8B, since the G display device 110G is located on the second circular arc a2 perpendicularly crossing the first circular arc a1 where the R and B display devices 110R and 110b are located, the first lenticular lens 230 is arranged such that the longitudinal axis thereof is in parallel with the direction where the R and B display devices 110R and 110B are arranged. Here, the first longitudinal axis of the lenticules of the first lenticular lens 230 is arranged to be perpendicular to the second longitudinal axis of the lenticules of the second lenticular lens 250.

For example, when the R and B display devices 110R and 110B are arranged in the horizontal direction and the G display device 110G is arranged in a direction perpendicular to the direction in which the R and B display devices 110R and 110B are arranged, the first lenticular lens 230 is arranged such that the longitudinal axis thereof is identical to the horizontal direction. In this case, the first lenticular lens 230 diffuses the incident light in the vertical direction to enlarge the viewing angle of the vertical direction and corrects the color shift in the vertical direction, which may be caused by the concentrating angle α of the G display device 110G in the vertical direction.

Alternatively, as shown in FIG. 11, the G display device 110G may be arranged on a line having a first predetermined angle with respect to a direction where the R and B display devices 110R and 110B are arranged. In this case, the G display device 110G may be arranged on the line having a second predetermined angle with respect to a plane (the x-z plane) vertical to the reference axis A.

FIG. 11 illustrates the R, G and B display devices 110R, 110G and 110B arranged on a curved surface of a circular cone having a predetermined cone angle, in which the R and B display devices 110R and 110B are disposed on the x-y plane in a horizontal direction and the G display device 110G is disposed on a line having an angle with respect to the x-z plane.

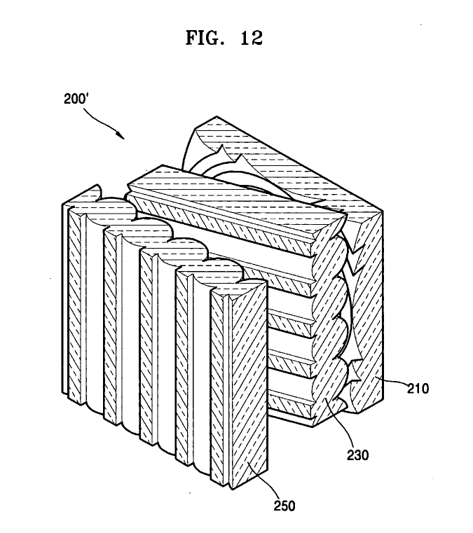

When the R, G and B display devices 110R, 110G and 110B are arranged as in FIG. 11, first and second lenticular lenses 230′ and 250 of a screen 200′ may be arranged as shown in FIG. 12.

Referring to FIG. 12, when the R, G and B display devices 110R, 110G and 110B are arranged as shown in FIG. 11, the second lenticular lens 250 is arranged as shown in FIGS. 9 through 10B and the first lenticular lens 230 is arranged such that a longitudinal axis of lenticules thereof is inclined at a predetermined angle with respect to the horizontal direction. The predetermined angle is identical to an angle at which a line or plane on which the G display device is disposed is inclined with respect to a plane obtained by the vertical direction and the reference axis A. Here, the screen 200′ depicted in FIG. 12 may be identical to that depicted in FIG. 9 except for the predetermined angle of the first lenticular lens 230.

When the R, G and B display devices 110R, 110G and 110B are arranged as shown in FIG. 11 and the first and second lenticular lenses 230 and 250 of the screen 200′ are arranged as shown in FIG. 12, the first lenticular lens 230 enlarges the viewing angle of the vertical direction and corrects the color shift that may be caused by the concentrating angle of the G display device 110G, and the second lenticular lens 250 enlarges the viewing angle of the horizontal direction and corrects the color shift that may be caused by the concentrating angles of the R and B display devices 110R and 110B in the horizontal direction.

In the screens 200 and 200′ depicted in FIGS. 9 through 10B and 12, the first and second lenticular lenses 230 and 250 may be formed of a dual lenticular lens structure in which incident lenses 213 and 251 and emitting lenses 235 and 255 are formed on both surfaces in the form of array. Here, each of the incident and projection lenses 231 and 251 and 235 and 255 may be formed of a cylindrical lens. The longitudinal axes of the first and second lenticular lenses 230 and 250 correspond to the longitudinal axes of the cylindrical lenses used as the incident and emitting lenses 231 and 251 and 235 and 255.

The first and second lenticular lenses 230 and 250 diffuses light incident in a direction perpendicular to the longitudinal axes thereof to enlarge the viewing angle and reduces the color shift.

When the R, G and B display devices 110R, 110G and 110B are arranged as shown in FIG. 7, a longitudinal axis of the lenticules of the first lenticular lens 230 is in parallel to the horizontal direction and a longitudinal axis of the lenticules of the second lenticular lens 250 is in parallel to the vertical direction, as shown in FIGS. 9 through 10B.

When the R, G and B display devices 110R, 110G and 110B are arranged as shown in FIG. 11, a longitudinal axis of the lenticules of the first lenticular lens 230 is inclined at a predetermined angle with respect to the horizontal direction as shown in FIG. 12. Here, the predetermined angle is identical to an angle at which the G display device 110G is inclined with respect to a plane obtained by the vertical direction and the reference axis A. In addition, the longitudinal axis of the lenticules of the second lenticular lens 250 is in parallel with the vertical direction.

Meanwhile, the emitting lenses 235 and 255 of the respective first and second lenticular lenses 230 and 250 may be formed of a spherical or aspheric lens to solve the color shift. Furthermore, the incident and emitting lenses 231 and 251 and 235 and 255 of the respective first and second lenticular lenses 230 and 250 may be formed with a pitch that can avoid a moire interference.

The lens power (refraction) of the first and second lenticular lenses 230 and 250 may be set according to a demand condition of the viewing angle. Therefore, curvatures of the lenses are not limited to a specific value but varied according to the required refraction.

The second lenticular lens 250 may include black stripes disposed at areas between the emitting lenses 255 to absorb outer light as well as light scattered and emitted from the second lenticular lens 250. By the black stripes 257, a ghost phenomenon caused by the outer light can be prevented and a contrast ratio can be increased. The first lenticular lens 230 may also include black stripes disposed at areas between the emitting lenses 235.

The display quality of the above-described projection television was tested and the test results will be described hereinafter.

The test was conducted for the example where the R, G and B display devices 110R, 110G and 110B are arranged as shown in FIG. 7.

According to the test results, by the above-described arrangement of the R, G and B display devices 110R, 110G and 110B and the above-described structure of the screens 200 and 200′, the projection television has a viewing angle aH° of 35° or more in the horizontal direction and the viewing angle aV° of 10° or more in the vertical direction. That is, according to embodiments of the present general inventive concept, the projection television has a wide viewing angle in both the horizontal and vertical directions and a superior color shift characteristic.

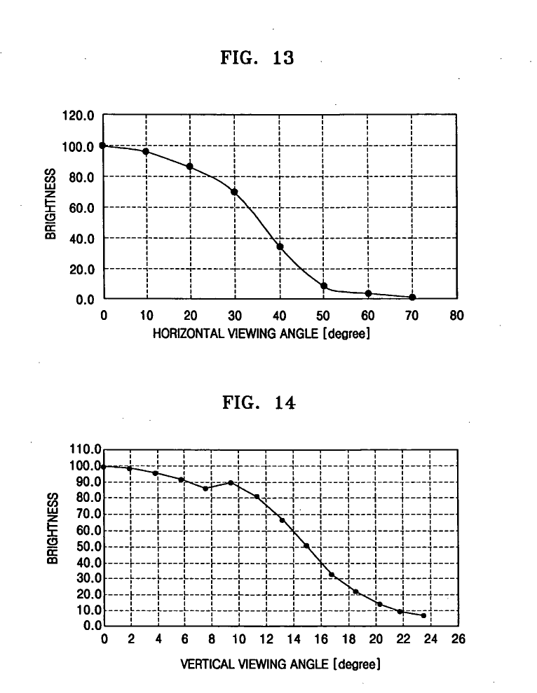

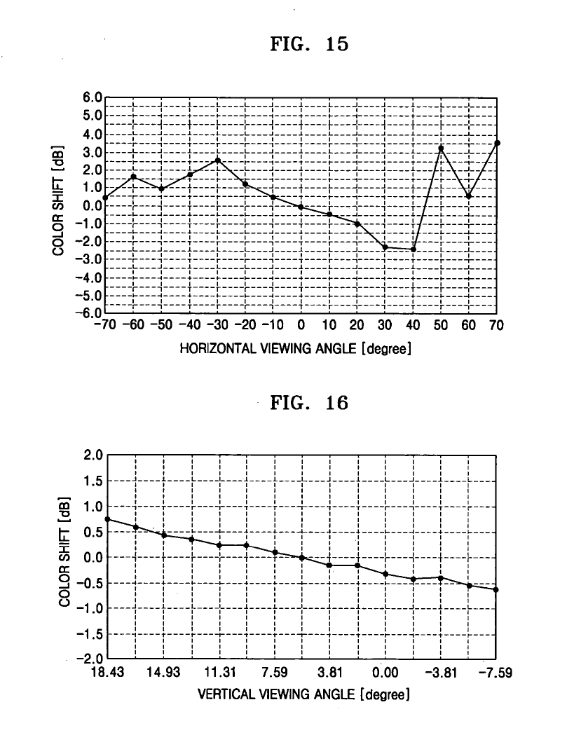

FIGS. 13 and 14 are graphs illustrating a brightness variation of the projection television according to the viewing angle in the horizontal and vertical directions. FIGS. 15 and 16 are graphs illustrating a color shift of the projection television according to the viewing angle in the horizontal and vertical directions.

The results illustrated in FIGS. 13 through 16 are obtained from an example where the R, G and B display devices 110R, 110G and 110B are arranged in three-dimension as shown in FIGS. 7 through 8B, in which the concentrating angle (direction cosine angle) α of the G display device 110G is about 2.90° and the concentrating angles (direction cosine angles) β and γ of the R and B display devices 110R and 110B are about 4.41°.

As can be noted from FIGS. 13 and 14, the projection television has the wide viewing angle in both the horizontal and vertical directions. Referring to FIGS. 13 and 14, the projection television has the viewing angle aH° of about 35.7° in the horizontal direction and the viewing angle aV° of about 15° in the vertical direction. Here, a range of the brightness that is half as much as a center brightness is generally represented as a range of the viewing angle. In FIGS. 13 and 14, the vertical axis represents the brightness on the bases of that the maximum brightness is 100.

According to the present general inventive concept, since the screen is arranged to properly correspond to the R, G and B display devices 110R, 110G and 110B that are three-dimensionally arranged, as shown in FIGS. 15 and 16, the superior color shift characteristic in the horizontal and vertical directions can be obtained. In FIG. 15, the horizontal axis represents the viewing angle in the horizontal direction while the vertical axis represents the maximum amount of the color shift in the horizontal direction using a dB unit. In FIG. 16, the horizontal axis represents the viewing angle in the vertical direction while the vertical axis represents the maximum amount of the color shift in the vertical direction using a dB unit.

Referring to FIG. 15, in a horizontal viewing angle within a range of −40°-+40°, a maximum color shift of 2.34 dB in the horizontal direction is incurred in the projection television. Referring to FIG. 16, a maximum color shift of 0.75 dB in the vertical direction is incurred in the projection television. It can be noted from FIG. 16 that even when the viewing angle in the vertical direction is 18.43°, the small color shift of about 0.75 dB is incurred.

As can be noted from the above, the projection television can maintain the viewing angle aH° of 35° or more in the horizontal direction and the viewing angle aV° of 10° or more in the vertical direction. That is, the projection television provides the wide viewing angle in both the horizontal and vertical directions while not deteriorating the center brightness. In addition, the color shift in the horizontal and vertical directions is has considerably good level within a proper range of the viewing angle.

Although the projection television is shown as embodiments of the present general inventive concept, the present general inventive concept is not limited thereto. That is, the present general inventive concept can be applied to a variety of projection systems in which a plurality of display devices are arranged to have a predetermined concentrating angle.

According to embodiments of the present general inventive concept, since the display devices are three-dimensionally arranged, the concentrating angle can be minimized, thereby improving a focusing characteristic, minimizing a convergence error of the R, G and B images, obtaining a sufficient convergence adjusting margin. Furthermore, focus and convergence deviations caused by the time/temperature variation can be remarkably reduced as compared with a conventional projection television.

Therefore, a high definition (HD) projection television can be realized by the present general inventive concept.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A projection television comprising:
a plurality of display devices to generate different images;
a plurality of projection lens units to magnify and project corresponding ones of the images generated from the display devices; and
a screen to display the projected images,
wherein the display devices are three-dimensionally arranged such that the display devices are concentrated around a reference axis that is a central axis of an arrangement of the display devices.

2. The projection television of claim 1, wherein the display devices are located on a spherical surface of a sphere having a radius identical to a total conjugate length of the projection lens units.

3. The projection television of claim 1, wherein the display devices are located on a plurality of circular arcs passing through the reference axis.

4. The projection television of claim 1, wherein:
the display devices comprise first, second and third display devices;
first and second display devices are arranged to be located on a first circular arc crossing the reference axis; and
the third display device is arranged to be located on a second circular arc crossing the reference axis.

5. The projection television of claim 4, wherein the first and second display devices are symmetrically arranged to have an identical concentrating angle with respect to the reference axis.

6. The projection television of claim 5, wherein the third display device is arranged to have a concentrating angle different from those of the first and second display devices.

7. The projection television of claim 4, wherein:
the first and second display devices are symmetrically arranged to have an identical concentrating angle with respect to the reference axis so that the first and second display devices can be located on the first circular arc in parallel with a horizontal direction; and
the third display device is located on the second circular arc that is perpendicularly cross the first circular arc.

8. The projection television of claim 7, wherein the third display device is arranged to have a concentrating angle different from those of the first and second display devices.

9. The projection television of claim 4, wherein:
the first and second display devices are symmetrically arranged to have an identical concentrating angle with respect to the reference axis so that the first and second display devices can be located on the first circular arc in parallel with a horizontal direction; and
the third display device is located on a line having at a predetermined angle with respect to a plane perpendicular to a plane where the first and second display devices are located.

10. The projection television of claim 9, wherein the third display device is arranged to have a concentrating angle different from those of the first and second display devices.

11. The projection television of claim 1, wherein at least one of the display devices is arranged to have a concentrating angle different from those of the rest of the display devices.

12. The projection television of claim 4, wherein the screen comprises:
a Fresnel lens to refract incident light from the projection lens units to be parallel light; and
first and second lenticular lenses to diffuse the images passing through the Fresnel lens to enlarge a viewing angle and to correct a color shift of the images.

13. The projection television of claim 12, wherein the first and second lenticular lenses comprise a dual lenticular lens having incidence and emitting lenses.

14. The projection television of claim 12, wherein one of the first and second lenticular lenses is arranged such that a longitudinal axis of the one of the first and second lenticular lenses is perpendicular to a direction in which the first and second display devices are arranged and the other one of the first and second lenticular lenses is arranged such that a longitudinal axis of the other one of the first and second lenticular is perpendicular to a direction where the third display device is arranged with respect to the reference axis.

15. A projection apparatus comprising:
first, second, and third display devices to generate different images, the first and third display devices disposed on a first circular line, and the second display device disposed on a second circular line different from the first circular line;
a projection lens unit to magnify and project the images generated from the display devices; and
a screen to display the projected images.

16. The projection apparatus of claim 15, wherein the second display device is spaced apart from the first circular line.

17. The projection apparatus of claim 15, wherein the first and second circular lines are disposed on a spherical surface.

18. The projection apparatus of claim 15, wherein the first and second circular lines are disposed on a round surface of a frustum of a cone.

19. The projection apparatus of claim 15, wherein the first and second circular lines are not disposed on a same plane.

20. The projection apparatus of claim 15, wherein the first, second, and third display devices respectively have first, second, and third angles with a reference axis that is a central axis of an arrangement of the display devices.

21. The projection apparatus of claim 15, wherein the screen comprises:
a Fresnel lens to refract incident light from the projection lens unit to be parallel light;
a first lenticular lens having a plurality of first lenticules having a first lengthwise direction; and
a second lenticular lens having a plurality of second lenticules having a second lengthwise direction, so that the images passing through the Fresnel lens are diffused, a viewing angle is enlarged, and a color shift of the images is corrected.

22. The projection apparatus of claim 21, wherein the first lenticules are formed on both sides of the first lenticular lens.

23. The projection apparatus of claim 21, wherein the first lengthwise direction has an angle with the second lengthwise direction.

24. The projection apparatus of claim 21, wherein one of the first lengthwise direction and the second lengthwise direction is perpendicular to the first circular line.

25. The projection apparatus of claim 21, wherein the first lengthwise direction and the second lengthwise direction have an angle with a plane perpendicular to the second circular line.

26. The projection apparatus of claim 21, wherein the first lenticular lens comprises stripes each disposed between the adjacent first lenticules so as to prevent a ghost phenomenon and increase a contrast ratio.

27. A projection apparatus comprising:
first, second, and third display devices to generate different images, the first and third display devices disposed on a plane including a central axis of an arrangement of the first, second, and third display devices, the second display device spaced-apart from the plane; and
a screen to display the generated images.

28. The projection apparatus of claim 27, wherein the second display device is disposed on a second plane different from the plane.

29. The projection apparatus of claim 27, wherein the second display device is disposed on a second plane having an angle with the plane.

30. The projection apparatus of claim 27, wherein the first and third display devices disposed on a line disposed on the plane, and the second display device is disposed to be spaced-apart from the line.

31. The projection apparatus of claim 27, wherein the first and third display devices disposed on a line disposed on the plane, and the second display device is disposed on a second plane different from the plane.

32. A projection apparatus comprising:
first, second, and third display devices respectively disposed on first, second, and third planes each including a common reference axis which is a central axis of an arrangement of the first, second, and third display devices, the second display device spaced-apart from the first and third planes; and
a screen to display the generated images.

33. The projection apparatus of claim 32, wherein the second plane is not parallel to the first plane and the second plane.

34. The projection apparatus of claim 32, wherein the first and third planes are a same plane, and the second plane has an angle with the same plane.

35. The projection apparatus of claim 32, wherein the first, second, and third display devices each are disposed in a lengthwise direction toward a center of the central axis.
